(19) United States
(12) Patent Application Publication
(10) Pub. No.: US 2022/0035215 A1
(43) Pub. Date: Feb. 3, 2022

(54) HIGH-EFFICIENCY ELECTRODEPOSITION FOR COATING ELECTROCHROMIC FILMS

(71) Applicant: The Regents of the University of Calfornia, Oakland, CA (US)

(72) Inventors: Yeyue CHEN, Albany, CA (US); Ruilhan GUO, Albany, CA (US)

(73) Assignee: The Regents of the University of Calfornia, Oakland (US)

(21) Appl. No.: 17/276,727

(22) PCT Filed: Sep. 17, 2019
(86) PCT No.: PCT/US2019/051542

§ 371 Date: Mar. 16, 2021

Related U.S. Application Data
(60) Provisional application No. 62/732,453, filed on Sep. 17, 2018.

(51) Int. Cl. G02F 1/155; C25D 9/08

(52) U.S. Cl. CPC G02F 1/155; C25D 9/08

(57) ABSTRACT

A method of producing an electrochromic device includes providing a substrate; providing a counter electrode; immersing the substrate and the counter electrode into an electrodeposition solution; applying a negative bias voltage to a surface of the substrate so that the surface of the substrate acts a cathode in the electrodeposition solution; applying a positive bias voltage to the counter electrode so that the counter electrode acts as an anode in the electrodeposition solution; and applying a voltage of at least 0.2 V between the anode and the cathode for period of time until a tungsten-based film forms on the surface of the substrate.

### CROSS-REFERENCE TO RELATED APPLICATIONS

The present patent application claims priority benefit to U.S. Provisional Patent Application No. 62/732,453 filed on Sep. 17, 2018, the entire content of which is incorporated herein by reference. All references cited anywhere in this specification, including the Background and Detailed Description sections, are incorporated by reference as if each had been individually incorporated.

### BACKGROUND

### 1. Technical Field

The field of currently claimed embodiments of this invention relates to methods of producing electrochromic devices and the devices produced.

### 2. Discussion of Related Art

Current color-tunable sunglasses mostly use photochromic materials that are triggered by light. However, ten minutes or longer changing time between bleached and colored status, as well as the inability of autonomic regulation, results in an inferior user experience. A better solution is provided by electric control products using electrochromic materials due to their relatively rapid response and good controllability. Electrochromic devices have been widely studied both in the industrial and academic fields. Tungsten trioxide (WO₃) is the most widely investigated electrochromic material that can change color through electrical potential difference.

Current electrochromic WO₃ thin films are mostly realized by a chemical vapor deposition (CVD) method, sputtering methods, electron-beam evaporation methods, plasma polymerization methods or sol-gel methods. However, each of the above methods is limited by its disadvantages. The CVD method requires expensive facilities and a relatively high temperature around 500° C. to maintain the deposition speed. The difficulty of keeping conformal films also presents other challenges. Sputtering methods require complicated equipment as well as inert or reactive gas. Electron-beam evaporation may be subject to contamination due to the ionization of gas molecules caused by X-rays. A vacuum condition, which increases the cost, is also needed in plasma polymerization. In addition, a low deposition rate achieved by the electron-beam evaporation method means only very thin films can be deposited for a large scale. Sol-gel methods relieve the film coating process from vacuum environment requirement and expensive equipment. However, controlling the sol-gel method can be challenging. In sol-gel methods, spin coating is limited by the rotating plate so only small samples can be coated. Dip coating requires a relatively large amount of solution and many variables are needed to be controlled.

Accordingly, there remains a need for improved methods of producing electrochromic devices and for improved electrochromic devices.

### SUMMARY

An aspect of the present invention is to provide a method of producing an electrochromic device. The method includes providing a substrate and providing a counter electrode. The method further includes immersing the substrate and the counter electrode into an electrodeposition solution, and applying a negative bias voltage to a surface of the substrate so that the surface of the substrate acts a cathode in the electrodeposition solution. The method also includes applying a positive bias voltage to the counter electrode so that the counter electrode acts as an anode in the electrodeposition solution, and applying a voltage of at least 0.2 V between the anode and the cathode for period of time until a tungsten-based film forms on the surface of the substrate.

In an embodiment, the substrate has a sheet resistance between about 7Ω/sq and about 20Ω/sq. In an embodiment, the substrate has a sheet resistance of about 15Ω/sq.

In an embodiment, applying the voltage between the anode and the cathode includes applying a voltage between 0.2 V and 1.2 V. In an embodiment, applying the voltage between the anode and the cathode includes applying a voltage between 1 V and 10 V. In an embodiment, applying the voltage of at least 0.2 V between the anode and the cathode for period of time includes applying a voltage of at least 0.2 V between the anode and the cathode for a time period between 2 minutes and 15 minutes depending on the voltage applied.

In an embodiment, the counter electrode includes an oxygen evolution reaction (OER) catalyzer. In an embodiment, the oxygen evolution reaction catalyzer includes IrO₂, RuO₂, or Fe₂O₃, or any combination thereof

In an embodiment, the method further includes forming the counter electrode by depositing a layer of the oxygen evolution reaction (OER) catalyzer on an electrically conductive substrate. In an embodiment, the electrodeposition solution includes hydrochloric acid, sodium tungstate dihydrate, oxalic acid and a metal chloride salt. In an embodiment, the metal chloride salt includes sodium chloride, potassium chloride, nickel chloride or cobalt chloride, or any combination thereof. In an embodiment, the formed tungsten-based film has an optically visible blue color.

In an embodiment, the method further includes, subsequent to the applying the voltage, immersing the tungsten-based film in de-ionized (DI) water until the blue color substantially disappears. In an embodiment, the method further includes, subsequent to the applying the voltage, annealing the substrate with the tungsten-based film formed thereon in air at a temperature between 100° C. and 500 ° C. for at least 1 hour. In an embodiment, the method further includes, subsequent to annealing, cooling the tungsten-based film to room temperature.

In an embodiment, the substrate is a fluorine-doped tin oxide (FTO) glass substrate. In an embodiment, the substrate includes indium tin oxide (ITO). In an embodiment, the tungsten-based film includes a tungsten oxide (WO₃) film.

Another aspect of the present invention is to provide an electrochromic device that is produced according to the above methods. In an embodiment, the electrochromic device changes from a colored state to a bleached state reversibly by applying a voltage.

### BRIEF DESCRIPTION OF THE DRAWINGS

The present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

FIG. 1 is a lateral view of an electrochromic film having a tungsten oxide film (WO₃) deposited on Fluorine doped Tin Oxide (FTO) glass substrate, according to an embodiment of the present invention;

FIG. 2A is a scanning electron microscope (SEM) image of the tungsten oxide (WO₃) film deposited on the FTO glass substrate before post treatment, according to an embodiment of the present invention;

FIG. 2B is a SEM image of the tungsten oxide (WO₃) film deposited on the FTO glass substrate, after annealing but without immersing the tungsten oxide film in water, according to an embodiment of the present invention;

FIGS. 3A and 3B are SEM images of the tungsten oxide (WO₃) film after immersing in water and before annealing, according to an embodiment of the present invention;

FIGS. 3C and 3D are SEM images of the tungsten oxide (WO₃) film after treatment, according to an embodiment of the present invention;

FIG. 4A is an image of the tungsten oxide film on the FTO glass substrate showing a coloration (blue color) in the tungsten oxide film, according to an embodiment of the present invention;

FIG. 4B is an image of the tungsten oxide film on the FTO glass substrate showing a bleaching process (discoloration) of the tungsten oxide film, according to an embodiment of the present invention;

FIG. 5A is an image of the tungsten oxide film on the FTO glass substrate showing a coloration (blue color) in the tungsten oxide film, according to another embodiment of the present invention; and

FIG. 5B is an image of the tungsten oxide film on the FTO glass substrate showing a bleaching process (discoloration) of the tungsten oxide film, according to another embodiment of the present invention.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

Improved electrochromic thin film coating process for industry has one or more of the following merits: vacuum-free; easy to control; rapid prototyping; materials saving; and cost-effective.

Electrodeposition is a pervasive coating method in the industry world. The film properties, including the crystallization, film density and film thickness can be tuned by changing reaction time and voltage. An embodiment of the current invention applies electrodeposition in coating tungsten trioxide (WO₃) electrochromic thin films uniformly. The uniform film provides a visible color contrast between bleached and colored status, and the switching time is within approximately one second, showing a competitive performance in the electrochromic industry. For example, the coating process is performed at normal temperature and pressure, and the solution is recoverable after being used, making this method adapted to industrial production.

Accordingly, an embodiment of this invention provides an innovative and efficient electrodeposition method for coating WO₃ thin film onto Fluorine doped Tin Oxide (FTO) glass substrates. However, other substrates can also be used, as along as the substrate includes Tin (Sn). For example, a substrate including Indium Tin Oxide (ITO) or other Tin-containing materials may also be used, according to some embodiments of the current invention. In an embodiment, the method includes:

a. Pretreatment: In an embodiment, an FTO glass substrate (having a surface resistivity or sheet resistance equal to about 15Ω/sq) is washed with acetone, ethanol and de-ionized (DI) water in an ultrasonic bath. Although a sheet resistance of 15Ω/sq is used in this example, the general concepts of the current invention are not limited to this particular example. The sheet resistance or surface resistivity of the glass substrate can vary from 7Ω/sq to 20Ω/sq according to some embodiments of the current invention without limitations. A larger sheet resistance coordinates with higher voltage.

b. Preparing an electrodeposition solution: In an embodiment, hydrochloric acid (HCl) is mixed with a sodium tungstate dihydrate (H₄Na₂O₆W) solution to make a green-yellowish tungstic acid solution. Therefore, the electrodeposition solution contains tungsten. In an embodiment, oxalic acid (C₂H₂O₄) is added to make a clear and stable solution at room temperature. In an embodiment, metal chloride salts (e.g., sodium chloride, potassium chloride, nickel chloride, cobalt chloride) are then added to the solution.

c. Preparing a counter electrode: In an embodiment, in a two-electrode system, a counter electrode is believed to have an impact on producing uniform thin films. A function of the counter electrode is to improve Oxygen Evolution Reaction (OER). In an embodiment, OER catalyzers that can support acidic environments are preferred as materials for the counter electrode. Examples of OER catalyzers include, but not limited to, IrO₂, RuO₂, Fe₂O₃. These OER catalyzers surprisingly show good thin film facilitation. A layer of the OER catalyzers (e.g., IrO₂, RuO₂, Fe₂O₃) can be deposited (e.g., sputtered, evaporated or simply brushed) onto an electrically conductive substrate to form the counter electrode.

d. Electrodeposition process:
1. The FTO glass and counter electrode are both vertically immersed into the electrodeposition solution prepared in step (b).
2. A positive bias voltage is applied to the counter electrode while a negative bias voltage is applied to a surface of the FTO glass substrate. Hence, the surface of the FTO glass substrate to which the negative voltage is applied acts as a cathode FTO surface in the electrodeposition solution, and the counter electrode acts as an anode in the electrodeposition solution. In an embodiment, the voltage and reaction time can be changed according to a size of the FTO glass substrate. For example, 0.2V to 1.2V can be applied during a coating time of 2 to 10 minutes for a 5 cm by 5 cm FTO glass substrate. For example, a voltage ranging from 1V to 10V can be applied during a coating time of 3 to 15 minutes to a 10 cm by 10 cm FTO glass substrate. In an embodiment, to achieve a uniform current density across the surface of 10 cm by 10 cm substrate, surrounding conductive tapes can be used.
3. As a result, a substantially uniform tungsten-based film having a blue color is formed on the cathode FTO surface.

e. Post treatment: In some embodiments, the formed blue tungsten oxide film can be sensitive to moisture in air due to its unstable property. Therefore, a post treatment is added to remove inserted hydrogen ions from the film. The post treatment includes (i) immersing the tungsten-based blue film in de-ionized (DI) water until the blue color disappears; (ii) drying the film over-night; (iii) annealing the tungsten-based film in air at a temperature between 100° C. and 500° C. for a time period between 1 hour and 3 hours; and then (iv) cooling down the tungsten-based film to room temperature.

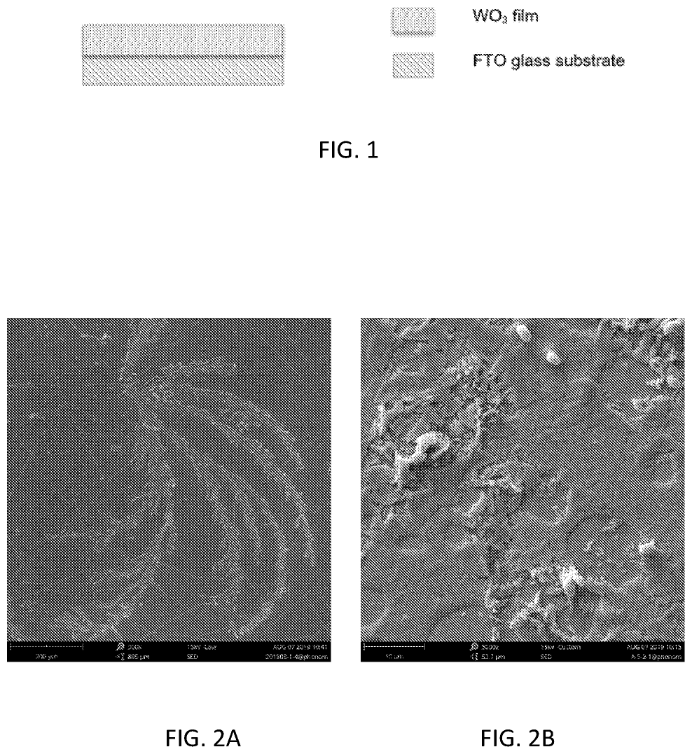

FIG. 1 is a lateral view of an electrochromic film having a tungsten oxide film (WO₃) deposited on Fluorine doped Tin Oxide (FTO) glass substrate, according to an embodiment of the present invention.

FIG. 2A is a scanning electron microscope (SEM) image of the tungsten oxide (WO₃) film deposited on the FTO glass substrate before post treatment, according to an embodiment of the present invention. FIG. 2B is a SEM image of the tungsten oxide (WO₃) film deposited on the FTO glass substrate, after annealing but without immersing the tungsten oxide film in water, according to an embodiment of the present invention.

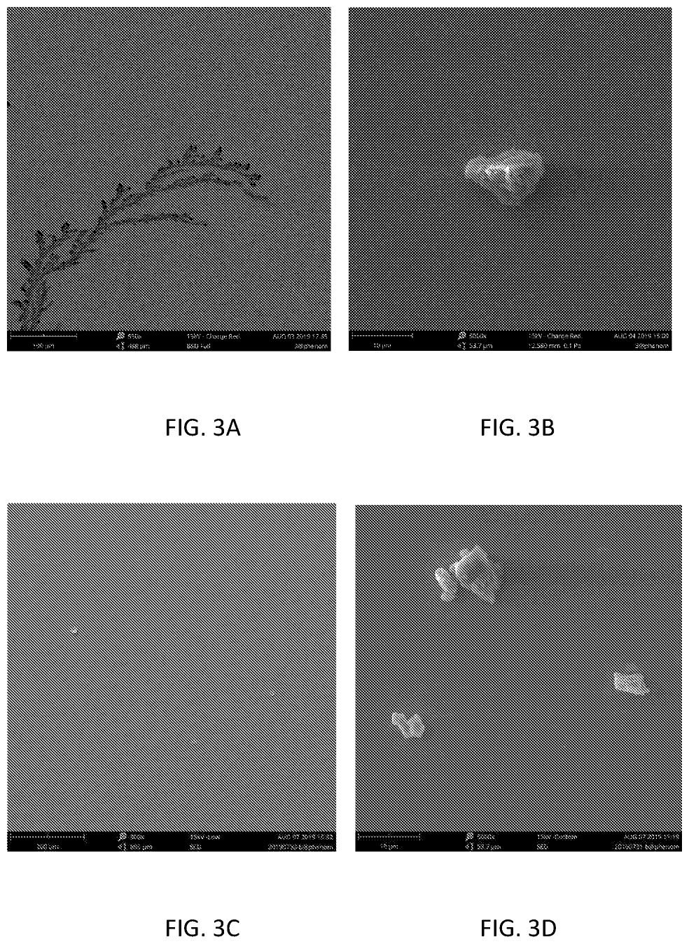

FIGS. 3A and 3B are SEM images of the tungsten oxide (WO₃) film after immersing in water and before annealing, according to an embodiment of the present invention. FIGS. 3A and 3B show the reduction and healing of cracks and morphology due to water immersion as well as a reduction in impurities.

FIGS. 3C and 3D are SEM images of the tungsten oxide (WO₃) film after treatment, according to an embodiment of the present invention. FIGS. 3C and 3D show that the post treatment can be surprisingly effective on the tungsten oxide film by substantially reducing or eliminating most of cracks in the WO₃ film.

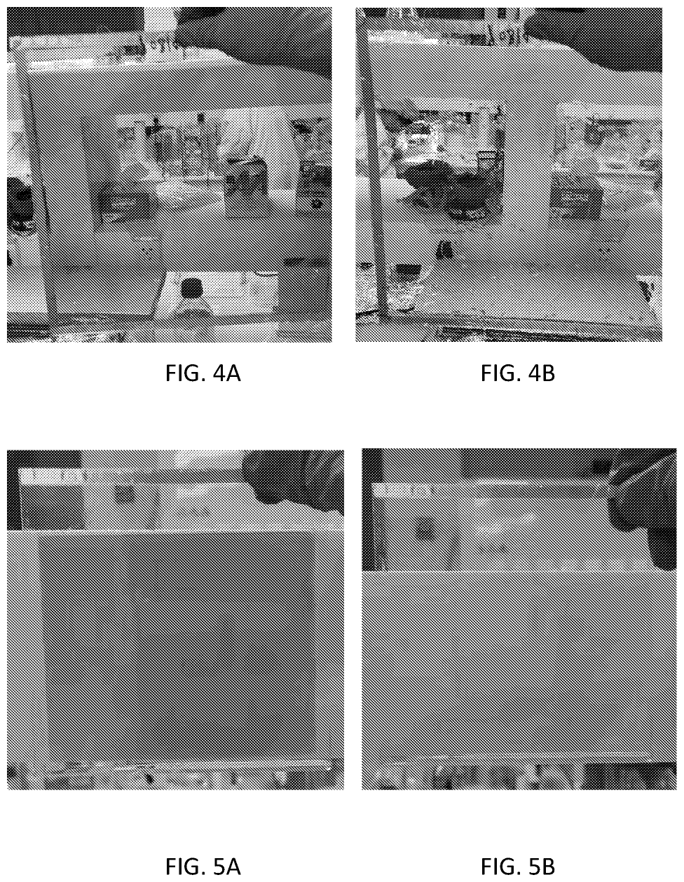

FIG. 4A is an image of the tungsten oxide film on the FTO glass substrate showing a coloration (blue color) in the tungsten oxide film, according to an embodiment of the present invention. FIG. 4B is an image of the tungsten oxide film on the FTO glass substrate showing a bleaching process (discoloration) of the tungsten oxide film, according to an embodiment of the present invention. In an embodiment, a size of the tungsten oxide film is about 30 cm by 30 cm.

FIG. 5A is an image of the tungsten oxide film on the FTO glass substrate showing a coloration (blue color) in the tungsten oxide film, according to an embodiment of the present invention. FIG. 5B is an image of the tungsten oxide film on the FTO glass substrate showing a bleaching process (discoloration) of the tungsten oxide film, according to an embodiment of the present invention. In an embodiment, a size of the tungsten oxide film is about 10 cm by 10 cm.

The post-treated tungsten oxide film can perform coloration and bleaching cycle reversibly with promising endurance in oxygen and water. The electrochromic device having the post-treated tungsten oxide film changes from a colored state to a bleached state reversibly by applying a voltage. The term “bleached” or “bleaching” is used in the art as meaning relatively “colorless” or relatively optically transparent. Therefore, the process of “bleaching” means changing from a colored state to a bleached colorless or discolored state.

### REFERENCES

1. U.S. Pat. No. 6,297,900

2. C. G. GRANQVISI, Thin Solid Films, 1990, 193, 730

3. US Patent Application Publication No. US20130128336A1

4. U.S. Pat. No. 5,883,762

5. US Patent Application Publication No. US20040118691A1

6. D. R. Rosseinsky, R. J. Mortimer, Adv. Mater., 2001, 13, 783

7. M. H. Kim, T. Y. Kang, Y. S. Jung, K. H. Kim, Japanese Journal of Applied Physics, 2013, 52, 05EC03

8. J. S. E. M. Svensson, C. Granqvist, Solar Energy Materials, 1984, 11, 29

9. Y. Lv, J. Song, Y. Lian, Y. Yu, X. Liu, Z. Zhuang. J. Nucl. Mater. 2015, 457, 317

10. C. Brigouleix, P. Topart, E. Bruneton, F. Sabary, G. Nouhaut, G. Campet, Electrochimica. Acta, 2001, 46, 1931

11. H. Maier, J. Luthin, M. Balden, J. Linke, F. Koch, H. Bolt, Surface and Coatings Technology, 2001, 142, 733

12. H. K. Yasuda, Academic Press, Plasma Polymerization, 2012, 399

13. Z. Xie, L. Gao, B. Liang, X. Wang, G. Chen, Z. Liu, J. Chao, D. Chen, G. Shen, J. Mater. Chem., 2012, 22, 19904

14. J. Xue, Y. Zhu , M. Jiang, J. Su, Y. Liu, Mater. Lett., 2015, 149, 127

15. P. K. Bhattacharya, A. Reisman, M. C. Chen, JEM, 1988, 17, 273

16. US20170218138A1

17. J. Zhang, J. Tu, X.Xia, X. Wang, C. Gu, J. Mater. Chem., 2011, 21, 5492

18. G. Yuan, C. Hua, L. Huang, C. Defranoux, P. Basa, Y. Liu, C. Song, G. Han, Appl. Surf Sci., 2017, 421, 630

19. H. UNUMA, K. TONOOKA, Y. SUZUKI, Journal of Materials Science Letters, 1986, 5, 1248

20. Z. Yua, X. Jia, J. Du, J. Zhang, Sol. Energy Mater Sol. Cells, 2000, 64, 55 G. Leftheriotis, P. Yianoulis, Solid State Ionics, 2008, 179, 2192

Devices according to some embodiments of the current invention can be used in producing WO₃ thin films in a cost-effective, less time-consuming way, which boosts the commercialization in the electrochromic industry. WO₃ thin films can match up well with anodic materials for electrochromic devices, whose applications can be found in:

Smart windows that can automatically block heat, thus reducing the energy consumption by air conditioning;

Sunglasses and windshields of the car that could change color in few seconds to reduce the harm of the UV light;

Automatically dimming interior/exterior mirrors that could change color with glare car headlight to prevent the uncomfortable feeling of the dazzling light; and

Compatibility with optical display system to enhance the visual performance of Head-Up Displays (HUD) and Augmented Reality (AR).

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A method of producing an electrochromic device, comprising:
providing a substrate;
providing a counter electrode;
immersing said substrate and said counter electrode into an electrodeposition solution;
applying a negative bias voltage to a surface of the substrate so that the surface of the substrate acts as a cathode in said electrodeposition solution;
applying a positive bias voltage to the counter electrode so that the counter electrode acts as an anode in said electrodeposition solution; and
applying a voltage of at least 0.2 V between said anode and said cathode for period of time until a tungsten-based film forms on the surface of said substrate.

2. The method according to claim 1, wherein said substrate has a sheet resistance between about 7Ω/sq and about 20Ω/sq.

3. The method according to claim 2, wherein said substrate has a sheet resistance of about 15Ω/sq.

4. The method according to claim 1, wherein said applying the voltage between said anode and said cathode comprises applying a voltage between 0.2 V and 1.2 V.

5. The method according to claim 1, wherein said applying the voltage between said anode and said cathode comprises applying a voltage between 1 V and 10 V.

6. The method according to claim 1, wherein applying the voltage of at least 0.2 V between said anode and said cathode for period of time comprises applying a voltage of at least 0.2 V between said anode and said cathode for a time period between 2 minutes and 15 minutes depending on the voltage applied.

7. The method according to claim 1, wherein the counter electrode comprises an oxygen evolution reaction (OER) catalyzer.

8. The method according to claim 7, wherein the oxygen evolution reaction catalyzer is selected from the group consisting of IrO₂, RuO₂, and Fe₂O₃.

9. The method according to claim 1, further comprising forming the counter electrode by depositing a layer of the oxygen evolution reaction (OER) catalyzer on an electrically conductive substrate.

10. The method according to claim 1, wherein said electrodeposition solution comprises hydrochloric acid, sodium tungstate dihydrate, oxalic acid and a metal chloride salt.

11. The method according to claim 10, wherein the metal chloride salt is selected from the group consisting of sodium chloride, potassium chloride, nickel chloride and cobalt chloride.

12. The method according to claim 1, wherein the formed tungsten-based film has an optically visible blue color.

13. The method according to claim 12, further comprising, subsequent to the applying said voltage, immersing the tungsten-based film in de-ionized (DI) water until the blue color substantially disappears.

14. The method according to claim 1, further comprising, subsequent to the applying said voltage, annealing the substrate with the tungsten-based film formed thereon in air at a temperature between 100° C. and 500° C. for at least 1 hour.

15. The method according to claim 14, further comprising, subsequent to annealing, cooling the tungsten-based film to room temperature.

16. The method according to claim 1, wherein said substrate is a fluorine-doped tin oxide (FTO) glass substrate.

17. The method according to claim 1, wherein said substrate comprises indium tin oxide (ITO).

18. The method according to claim 1, wherein said tungsten-based film comprises a tungsten oxide (WO₃) film.

19. An electrochromic device produced according to a method comprising:
providing a substrate;
providing a counter electrode;
immersing said substrate and said counter electrode into an electrodeposition solution;
applying a negative bias voltage to a surface of the substrate so that the surface of the substrate acts as a cathode in said electrodeposition solution;
applying a positive bias voltage to the counter electrode so that the counter electrode acts as an anode in said electrodeposition solution; and
applying a voltage of at least 0.2 V between said anode and said cathode for period of time until a tungsten-based film forms on the surface of said substrate.

20. The electrochromic device according to claim 19, wherein the electrochromic device changes from a colored state to a bleached state reversibly by applying a voltage.
